(19) United States
(12) Patent Application Publication
(10) Pub. No.: US 2026/0316147 A1
(43) Pub. Date: Oct. 15, 2026

(54) Apparatus And Method For Shaping A Flat Wire Into The Form Of A Hairpin, For Use In The Manufacture Of A Motor Stator

(71) Applicant: Comau (Shanghai) Engineering Co., Ltd., Shanghai (CN)

(72) Inventors: Yunhui Gao, Shanghai (CN); Lei Suo, Shanghai (CN)

(21) Appl. No.: 19/486,131

(22) PCT Filed: May 17, 2024
(86) PCT No.: PCT/CN2024/093877

§ 371 Date: Nov. 20, 2025

(30) Foreign Application Priority Data
May 22, 2023 (CN) 202310579624.2

(51) Int. Cl. B21F 1/00; B21F 45/04

(52) U.S. Cl. CPC B21F 1/00; B21F 45/04

(57) ABSTRACT

An apparatus for shaping a flat wire into the form of a hairpin having a general U-shape, with two substantially parallel legs connected by a bridge portion, for use in the manufacture of a motor stator. The apparatus includes a stationary base plate, and first forming unit, for forming the wire into blank having a V-shaped bridge portion and two legs. A second forming unit is moved in a direction contrary to the direction of movement of the first forming unit for pushing laterally inwardly the two legs of the blank, so as to compensate for any spring-back effect of the two legs which are then substantially parallel. A third forming unit is vertically moved to a lowered position in which a mold member cooperates with a stationary mold member of a die structure to bring the blank into a final three-dimensional shape.

### CROSS-REFERENCE TO RELATED APPLICATIONS

This application is filed pursuant to 35 U.S.C. § 371 claiming priority benefit to PCT/CN2024/093877 filed May 17, 2024, which claims priority benefit to China Patent Application No. 202310579624.2 filed May 22, 2023, the contents of both applications are incorporated herein by reference in their entirety for all purposes.

### TECHNICAL FIELD

The present invention relates to apparatus and methods for shaping a flat wire into the form of a hairpin having a general U-shape, with two substantially parallel legs connected by a bridge portion, for use in the manufacture of a motor stator.

### BACKGROUND

With the development of the automotive industry in the field of vehicles with new propulsion systems, the market demand for electric and hybrid vehicles is greatly increasing. An electric propulsion system, as a component of an electric or hybrid vehicle, has a significant impact on power, economic efficiency, comfort, safety and service life of the vehicle. As a core of the electric propulsion system, the performance of an electric motor directly determines the performance of the vehicle to a great extent. Electric motors with stator windings including groups of flat wire hairpins have proved to be particularly advantageous. Flat wire motor windings are characterised by a small internal gap, a high slot filling rate, large contact areas between wires and between the winding and the iron core, so that heat dissipation and heat conduction performances are good, temperature rise is low and the overall performance of the motor is improved. Therefore, electric motors with flat wire hairpin windings have entered a large-scale mass production stage. A huge challenge is put forward for a large-scale production line of flat wire hairpins.

Examples of apparatus for shaping a wire into the form of a hairpin are known from documents U.S. Pat. Nos. 11,496,028B2 and 11,848,589B2. In the prior solutions, vertically operating molds are provided for shaping a wire into the form of a hairpin. However, the prior solutions do not enable a high production efficiency together with a uniform quality of the product.

A first need which is felt in this field is the provision of an apparatus of simple construction and reduced occupied space, which is adapted to be a part of a fully automatic production line of electric motors, for large-scale production.

Another problem to be solved is that of providing an apparatus which is able to ensure a high and uniform quality of the finished products. In this connection, a specific problem which is encountered in forming a hairpin is that at the end of the forming operation, the two legs of the formed product may be subjected to a spring-back effect, so that the two legs of the U-shaped hairpin do not remain in the correct positions, parallel to each other.

Therefore, there is a need for further improvements in this field.

### SUMMARY

It is therefore an object of the present invention to solve all the above indicated problems by providing an apparatus and a method for shaping a flat wire into the form of a hairpin, for use in the manufacture of a motor stator, which enable great efficiency and high productivity, while ensuring very good and uniform quality of the finished products.

A further more specific object of the invention is that of providing an apparatus which ensures that the two legs of the finished hairpin are in a proper substantially parallel configuration, in spite of any spring-back effect to which these legs may be subjected after the forming operation.

Another object of the invention is that of enabling the finished product to be rapidly evacuated from the apparatus so as to enable a new wire to be rapidly loaded, thus increasing productivity.

Another object of the invention is that of enabling the apparatus to be easily and flexibly adjusted to any new configuration and size of the finished product to be obtained.

In view of achieving one or more of the above indicated objects, the present invention provides an apparatus for shaping a flat wire into the form of a hairpin having a general U-shape, with two substantially parallel legs connected by bridge portion, for use in the manufacture of a motor stator, said apparatus comprising:
a stationary base plate,
a pair of stationary supports provided on the base plate which are configured to hold a substantially straight wire along a horizontal support direction, by holding the wire at two locations which are spaced apart from each other,
a first forming unit which is slidably mounted on the base plate along a horizontal first axis orthogonal to said horizontal wire support direction, and which is adapted to be moved by an actuator from a first rearward position towards a second forward position,
a stationary die structure carried by said base plate and configured to cooperate with a mold member of the first forming unit as a result of a movement of the first forming unit from its first rearward position to its second forward position, so as to form said wire into a bidimensional shaped blank having a V-shaped bridge portion and two substantially parallel legs,
a second forming unit which is slidably mounted on the base plate along said horizontal first axis, and which is adapted to be moved by an actuator from a third rearward position to a fourth forward position, in a direction contrary to the direction of the movement of the first forming unit from the first rearward position to the second forward position,
said second forming unit having lateral pushing members configured to slightly push laterally inwardly the two legs of said bidimensional shaped blank as a result of a movement of the second forming unit towards its fourth forward position, so as to compensate for any spring-back effect of the two legs, thereby leaving the two legs substantially parallel to each other when the second forming unit is returned to its third rearward position, and
a third forming unit, which is vertically movable relative to the base plate and which is adapted to be moved by an actuator from a raised position to a lowered positioning which a mold member of the third forming unit cooperates with a stationary mold member of the die structure to bring said bidimensional shaped blank into a final three-dimensional shape.

According to a further feature, said mold member of the first forming unit is a pointed front portion of the first forming unit and said die structure includes a die member configured to cooperate with the mold member of the first forming unit, when the first forming unit is in its second forward position, so as to form a central portion of the wire into a V-shaped bridge portion.

According to a further preferred feature, said two wire stationary supports are located and configured so as to act as additional die members, by compelling two opposite portions of the wire to be bent to form said two substantially parallel legs when the central portion of the wire is pushed between and beyond the two supports by the mold member of the first forming unit, as a result of the movement of the first forming unit towards its second forward position,
so that the forward movement of the first forming unit causes the forming of the V-shaped bridge portion and also of the two parallel legs of said bidimensional blank.

In a preferred example, said second forming unit includes:
a slide structure movable along said horizontal first axis on the base plate,
said lateral pushing members being in the form of two lateral arms carried by said slide structure and movable transversally to said horizontal first axis relative to the slide structure,
wire engaging elements carried by said lateral arms and configured to laterally engage the two legs of said bidimensional blank from outside, and
cam means, configured to cause a transverse movement of said lateral arms as a result of the movement of the second forming unit from its third rearward position to its fourth forward position, in such a way that said engaging elements push laterally inwardly the two legs of said bidimensional shaped blank towards each other, so that when the second forming unit is returned to its third rearward position, the two legs of the bidimensional blank return to a position in which they are substantially parallel to each other.

Preferably, said two lateral arms are pivotally mounted around vertical axes on said slide structure of the second forming unit, and said cam means comprise cam surfaces provided on said lateral arms and configured for engaging cooperating members, so that a movement of the slide structure of the second forming unit from said third rearward position to said fourth forward position causes a rotation of the lateral arms towards each other, and so that said wire engaging elements carried by said lateral arms push the two legs of said bidimensional blank towards each other.

Also preferably, said wire engaging elements are freely rotatable rollers carried by said lateral arms.

Also preferably, said cooperating members are freely rotatable rollers carried by stationary supports, springs being operatively interposed between each of said lateral pivoting arms and the slide structure of the second forming unit, urging each lateral pivoting arm against the respective cooperating roller.

Also preferably, each cooperating roller is adjustable in position along a direction orthogonal to said first axis.

Due to the above indicated features, the present invention can be advantageously used in an automatic production line. In the invention, the final three-dimensional shape of the hairpin is obtained very simply, by firstly forming a bidimensional U-shaped blank, and then bringing the bidimensional shaped blank into a final three-dimensional shape. Moreover, the provision of horizontally movable first forming unit and second forming unit enables higher productivity and also easier expulsion of the finished product at the end of the forming operation. Furthermore, the provision of the second forming unit with laterally pushing members configured to slightly push lateral inwardly the two legs of the bidimensional shaped blank, enables a final product to be obtained, having two parallel legs, in spite of any spring-back effect to which the legs may be subjected after the forming operation.

The apparatus of the present invention has a relatively simple and compact structure, with reduced occupied space. The die members cooperating with the first forming unit and the third forming unit are located adjacent to each other, so that the space is concentrated and multiple auxiliary systems are shared, so that the occupied area is greatly reduced. Moreover, the length of the discharging facility for discharging the formed hairpin can be greatly reduced, which therefore reduces the investment cost for the production line and for the energy consumption.

The apparatus of the invention can be easily and precisely adjusted according to any specific form and size of the hairpin to be obtained. Each forming unit can be independently adjusted, while keeping a high precision in operation. Therefore, also dead times for maintenance and adjustment of the apparatus are greatly reduced, which also reduces production losses.

In the apparatus of the present invention, the mounting operations are simple, adjustment operations are simple and convenient and maintenance operations are convenient. Assembling time, debugging time and maintenance time can be greatly shortened, so that the utilization rate of the production line is greatly increased.

### BRIEF DESCRIPTION OF THE DRAWINGS

Further features and advantageous of the invention will become apparent from the following description, with reference to the accompanying drawings, given purely by way of non-limiting examples, in which:

FIG. 1 is a top view of one embodiment of the apparatus according to the present invention,

FIG. 2 is a side view of the apparatus of FIG. 1,

FIG. 3 is a perspective view of the apparatus of FIGS. 1, 2,

FIG. 4 is a top view at an enlarged scale of a detail of the apparatus of the invention,

FIG. 5 is another perspective view of the apparatus of the invention,

FIG. 6 shows a V-shaped blank,

FIG. 7 is a schematic diagram of a bidimensional U-shaped blank which is obtained in a first stage of the forming operation, by the apparatus of the invention,

FIG. 8 is a schematic diagram of the final product, having a three-dimensional shape, which is obtained by the apparatus of the invention,

FIG. 9, 10 show a top view at an enlarged scale of the first forming unit of the apparatus according to the invention, in two different operative positions,

FIG. 11 is a top view at an enlarged scale of the second forming unit of the apparatus according to this invention,

FIG. 12 is a perspective view of a detail of the second forming unit of FIG. 11,

FIG. 13, 14 are diagrams showing the principle of operation of the second forming unit,

FIG. 15 is a perspective view of the preferred embodiment of the apparatus according to the invention, at the end of the forming operation,

FIG. 16 is a perspective view at an enlarged scale of the die structure with mold members cooperating with the first forming unit and the third forming unit,

FIG. 17 shows another schematic diagram of the bidimensional U-shaped blank of FIG. 7,

FIG. 18 is another schematic diagram of the final product of FIG. 8,

FIG. 19 is another perspective view of the apparatus of the invention during discharge operation of the final product, and

FIG. 20 is a perspective view at an enlarged scale of a detail of the apparatus of FIG. 19, showing the discharging operation of the final product.

The annexed drawings show, purely by way of example, a preferred embodiment of an apparatus according to the invention for shaping a flat wire into the form of a hairpin having a general U-shape, with two substantially parallel legs connected by a bridge portion, for use in the manufacture of a motor stator. FIG. 8 and FIG. 18 show two examples of the finished product to be obtained, that is a hairpin H, including two substantially parallel legs H1 and a bridge portion H2, connecting the two legs H1, and formed in a three-dimensional shape.

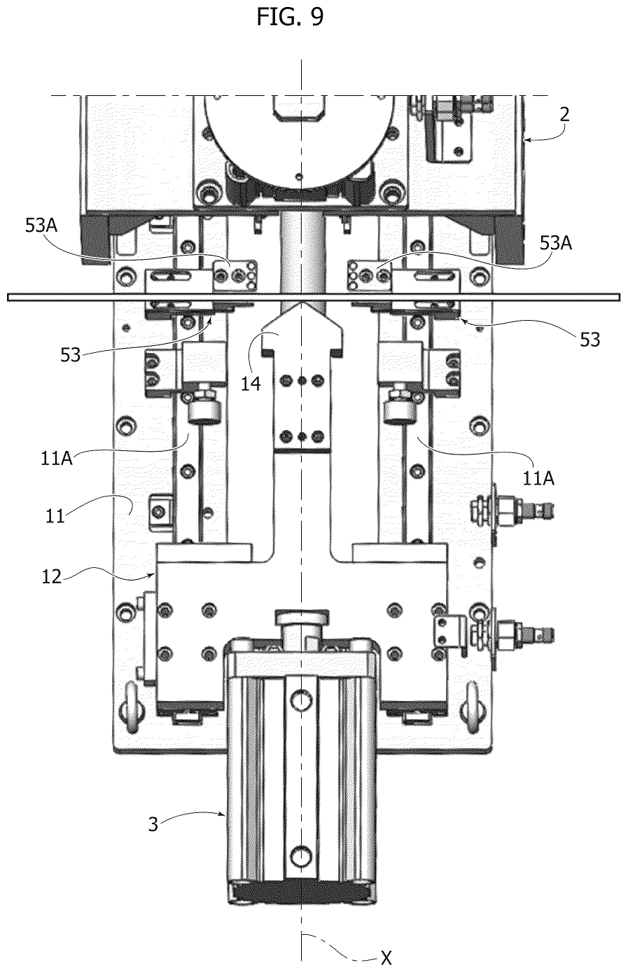

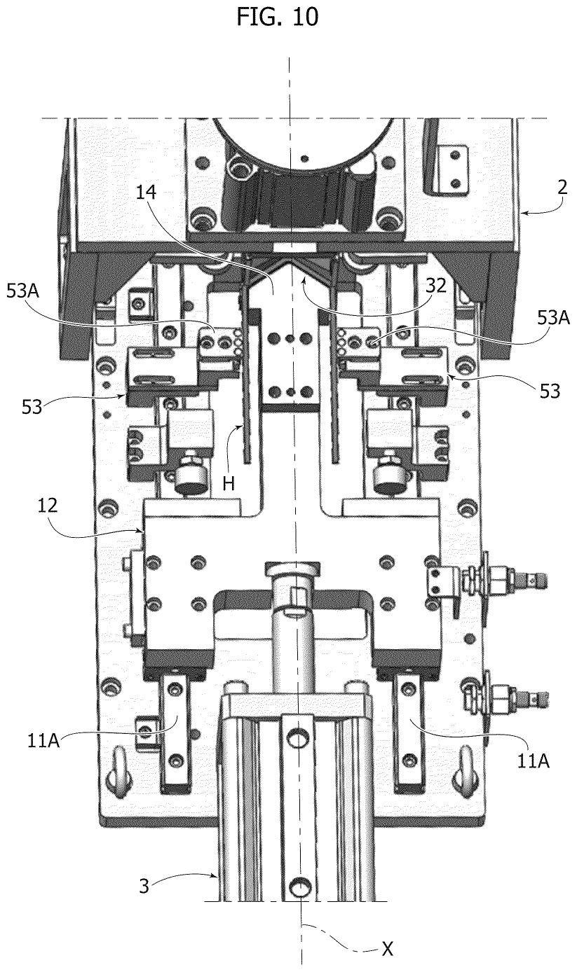

In the drawings, the apparatus of the invention is generally designated by 1. Apparatus 1 comprises a stationary base plate 11 and a pair of stationary supports 53 (better visible in FIGS. 9, 10 and 15) which are secured to the base plate 11. Preferably, supports 53 are mounted on the stationary base plate 11 so as to be adjustable in position along a direction parallel to a first longitudinal horizontal axis X of apparatus 1 and/or along a horizontal direction orthogonal to axis X. Supports 53 are configured to hold a substantially straight wire 52 along a horizontal support direction orthogonal to axis X of the apparatus. The two supports 53 hold wire 52 at two spaced apart locations (as better shown in FIG. 9), so that the central portion of wire 52 is free to be engaged by the mold member of the first forming unit of apparatus 1, as will be described in the following.

As indicated above, the apparatus of invention is configured for shaping a flat wire, i.e. a wire having a substantially flat cross-section, into the form of a hairpin such as that shown in FIG. 8 or FIG. 18. In this description, and in the following claims, the terms “flat wire” and “flat cross-section” are used to refer to a non-circular cross-section of the wire, including two opposite faces which are substantially planar and parallel to each other. However, the invention is applicable in principle also to the forming of a wire having a circular cross-section.

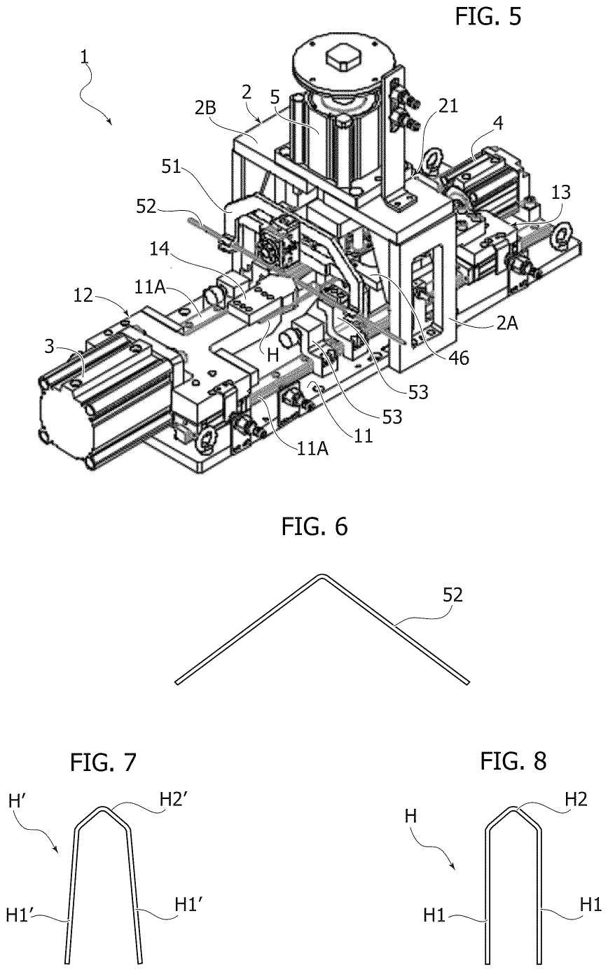

The present disclosure and the annexed drawings do not include a description of the means for loading the wire 52 onto the two supports 53 of the apparatus 1 of the invention. These loading means can be made in any known way and are preferably configured to enable a fully automatic loading operation, for example with the aid of a robot. FIG. 5 of the drawings shows an embodiment in which, a clamping jaw 51 is also provided for holding the wire in the apparatus according to the invention.

The apparatus of the invention includes a first forming unit 12, a second forming unit 13 and a third forming unit 21.

The first forming unit 12 is in the form of a sliding table which is slidably mounted on the base plate 11 along the horizontal first axis X, orthogonal to the horizontal direction along which wire 52 is supported.

As better visible in FIGS. 9, 10 and 19, the first forming unit 12 is slidable on two parallel and spaced apart rails 11A, secured to the upper surface of the base plate 11.

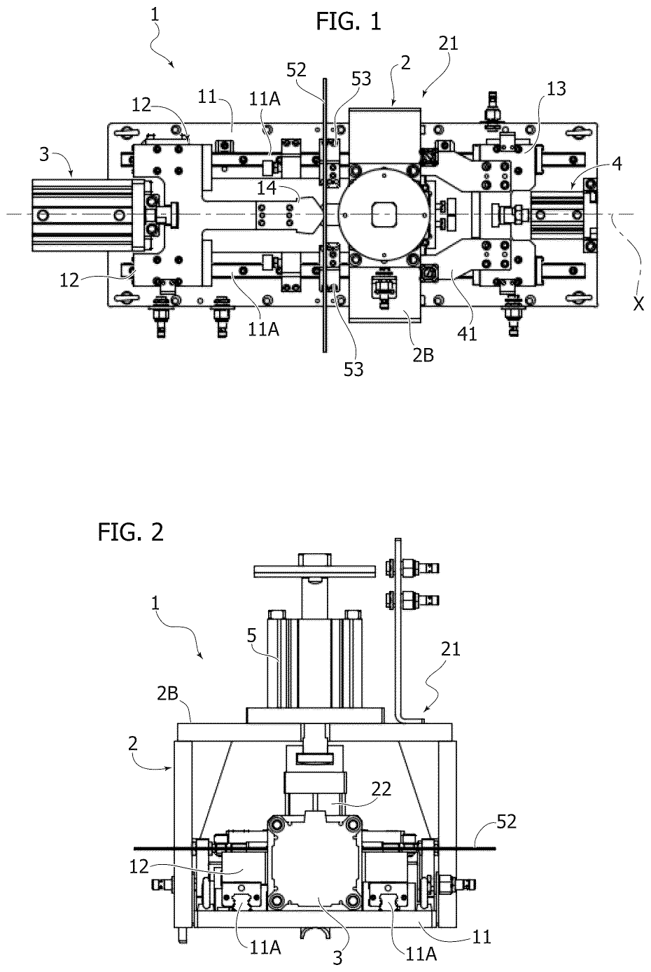

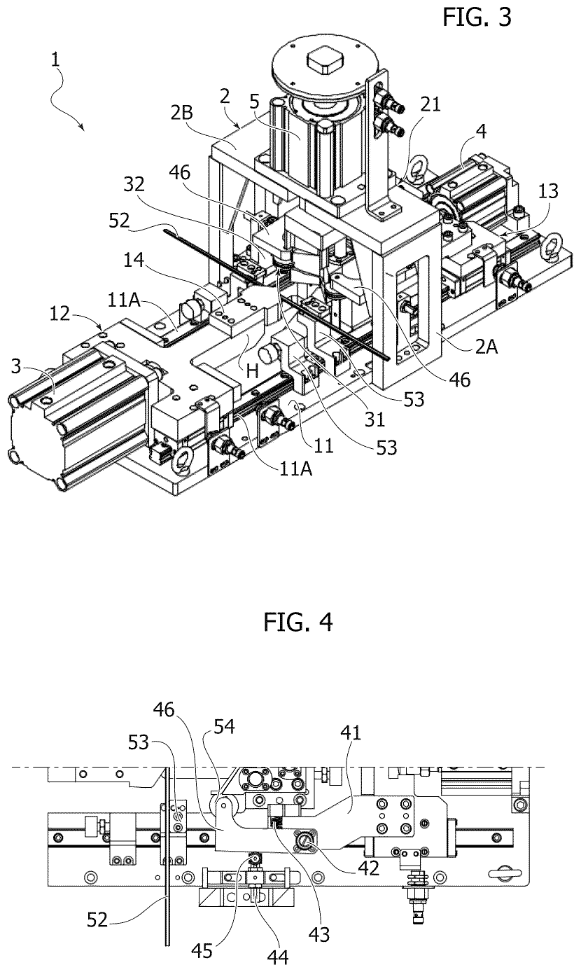

The first forming unit 12 can be moved, by means of an actuator 3, which is preferably in the form of a pneumatic cylinder, between a first rearward position (shown in FIGS. 1, 3, 5 and 9) and a second forward position (shown in FIG. 10). The first forming unit 12 includes a front portion defining a pointed mold member 14.

As shown in FIGS. 9, 10, when the first forming unit 12 is in its first rearward position, the mold member 14 is located upstream (with reference to its direction of movement towards its forward position) of the horizontal direction along which the wire 52 is supported. When the first forming unit 12 is in its second forward position, the mold member 14 has gone beyond the direction along which the wire 52 is originally supported. Therefore, as a result of the movement of the first forming unit 12 from its first rearward position to its second forward position, the mold member 14 engages the central portion of wire 52 and pushes the central portion of the wire 52 against a stationary mold 32, forming part of a die structure 31, which is secured above the base plate 11. In this manner, the mold member 14 of the first forming unit 12 and the cooperating stationary mold member 32, would cause the wire 52 to assume the V-shape shown in FIG. 6. However, in the illustrated example, the movement of the first forming unit 12 from its first rearward position to its second forward position causes, in one step, the forming of wire 52 into a bidimensional U-shaped blank H′, as shown in FIG. 7, with two legs H1′ and a bridge portion H2′. This result is achieved because the forward movement of mold member 14 causes the central portion of wire 52 to pass between and beyond two portions 53A of supports 53, which are located in such a way that opposite portions of wire 52 are compelled to be bent in a U-shape as shown in FIG. 10.

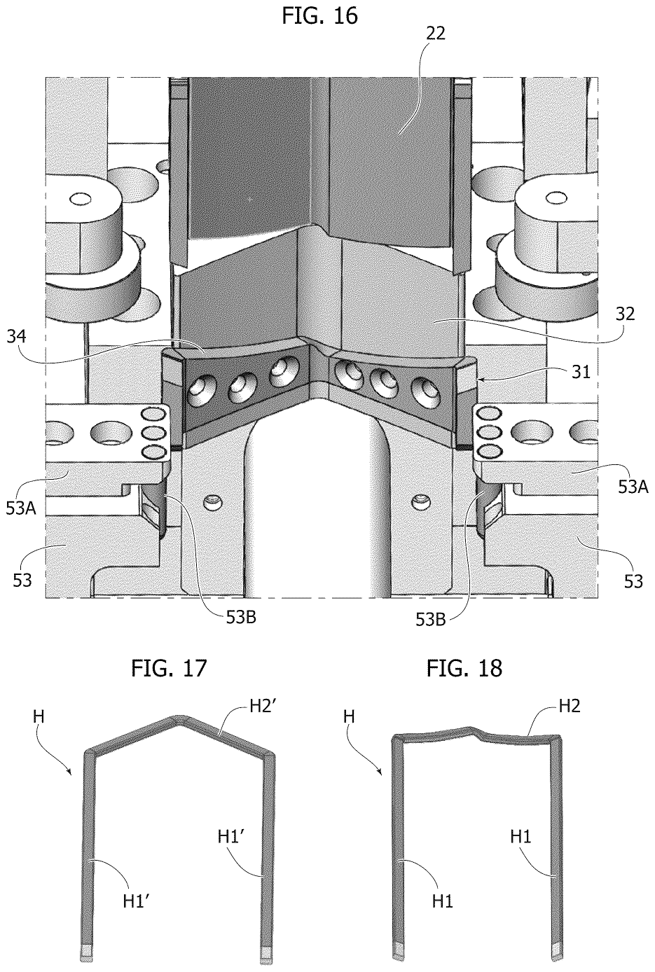

Preferably, the position of support portions 53A, both along rails 11A and along a horizontal direction orthogonal to rails 11A, is adjustable, depending upon the shape and size of the bidimensional U-shaped blank which must be obtained. As better visible in FIG. 16, each support portion 53A is preferably provided with vertical cylindrical pads 53B to make the sliding contact of the wire against the support portions 53A easier.

As clearly apparent from the foregoing description, the first forming unit 12 of the apparatus according to the invention is configured to operate along a horizontal direction and is able to obtain, in a one-step operation, a bidimensional U-shaped blank H′ as illustrated, for example, in FIGS. 7 and 17.

As indicated, the apparatus of the invention further comprises the second forming unit 13 in form of a sliding table 13A, which is slidably mounted along the horizontal first axis X on the base plate 11. In the illustrated example, the second forming unit 13 is slidably mounted on the same guiding rails 11A on which the first forming unit 12 is slidably mounted. In this manner, the construction of the apparatus can be simplified and the number of components can be reduced. However, the second forming unit could be slidably mounted on rails different from those on which the first forming unit 12 is mounted.

The second forming unit 13 can be moved between a third rearward position and a fourth forward position by means of an actuator 4, which is preferably in the form of a pneumatic cylinder, whose body is mounted on the base plate 11. The first forming unit 12 and the second forming unit 13 are located on opposite sides with respect to a central frame 2, mounted on the base plate 11. The second forming unit 13 is configured so that when it is moved from its third rearward position to its fourth forward position, it moves in a direction contrary to the direction of movement of the first forming unit 12, when the first forming unit 12 is moved from its first rearward position to its second forward position.

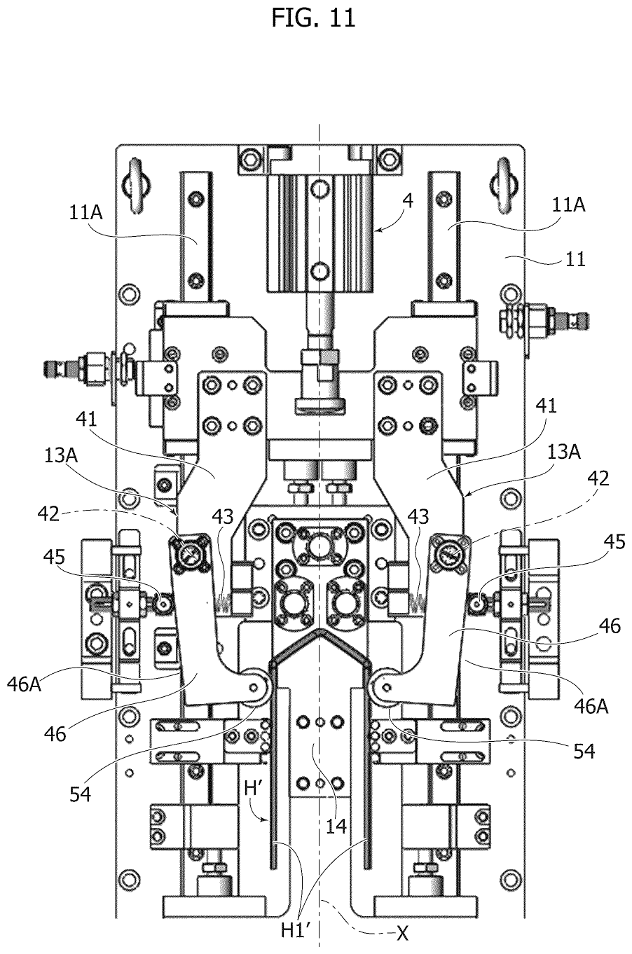

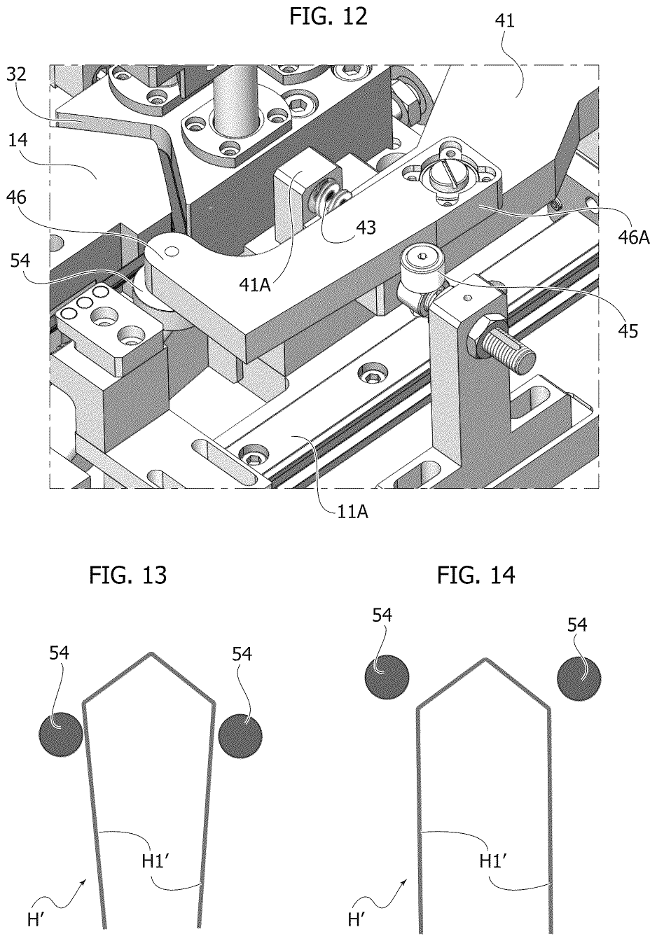

Referring in particular to FIGS. 11, 12, the second forming unit 13 is provided with two lateral pushing members 46, configured to slightly push laterally inwardly the two legs H1′ of the bidimensional U-shaped blank H′ so as to compensate for any spring-back effect of the two legs H1′, thereby leaving the two legs H1′ substantially parallel to each other when the second forming unit 13 is returned to its third rearward position.

In the illustrated example, the two lateral pushing members 46 are in the form of two lateral arms, carried by the structure of the second forming unit 13, and configured to be movable transversally relative to the first longitudinal horizontal axis X. In the illustrated example, the two lateral arms 46 are pivotally mounted around vertical axes 42 on two forwardly projecting supports 41 of the slide table 13A of the second forming unit 13.

According to the invention, cam means are provided, which are configured to cause a transverse movement of the lateral arms 46 as a result of the movement of the second forming unit 13 from its third rearward position to its fourth forward position, in such a way that the engagement elements 54 of the arms 46 push the two legs H1′ of the bidimensional U-shaped blank H′ laterally inwardly, so that when the second forming unit 13 is returned to its third rearward position, the two legs H1′ of the bidimensional blank H1 return to a position in which they are substantially parallel to each other, in spite of any spring-back effect.

In the illustrated embodiment, the engagement elements 54 carried by the lateral arms 46 are freely rotatable rollers. Also, in the illustrated example, the abovementioned cam means include bevel surfaces 46A on the outer sides of the lateral arms 46, which are configured to cooperate with respective cooperating members 45. In the illustrated example, the cooperating members 45 are freely rotatable rollers (see also FIG. 12) which engage the bevel surfaces 46A of the two lateral arms 46.

Two springs 43 are provided to urge each lateral arm 46 against the cooperating roller 45. Each spring 43 is operatively interposed between each arm 46 and a bracket 41A of the respective support 41 as better shown in FIG. 12.

Due to the above-described structure and arrangement, a movement of the second forming unit 13 from its rearward position to its forward position causes a progressive engagement of the bevel surfaces 46A of the two arms 46 against the cooperating rollers 45, so that the two arms 46 are compelled to rotate towards each other, thus pushing the two legs H1′ of the bidimensional U-shaped blank H′ laterally inwardly, towards each other, by means of the engagement rollers 54.

As clearly shown in FIG. 12, the position of each cam cooperating roller 45 along a direction transverse relative to the first axis X can be adjusted, by any known means (by a screw adjuster in the illustrated example).

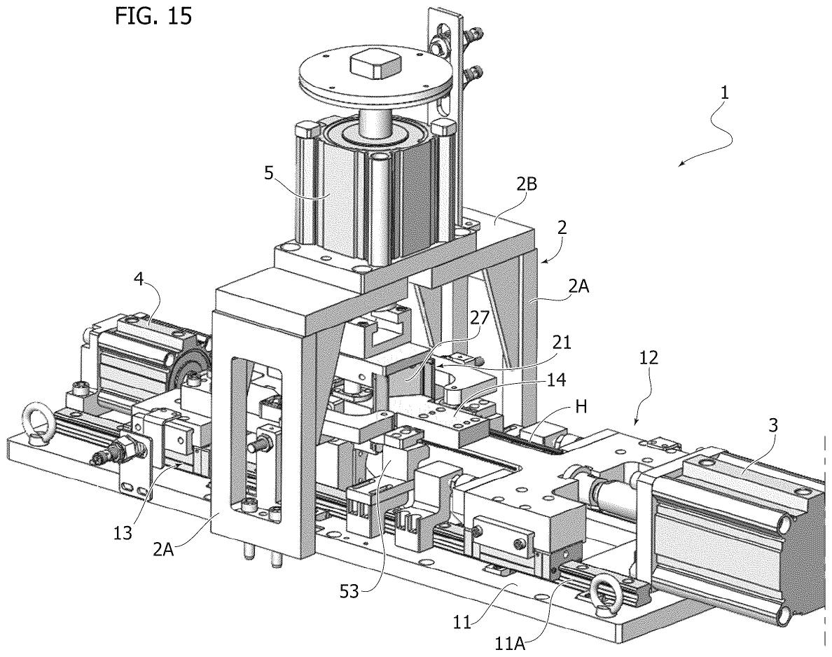

The above-described operation is further explained by the diagrams of FIGS. 13, 14, which diagrammatically show the bidimensional U-shaped blank H′ during and after the engagement of the engaging rollers 54 against the legs H1′.

As indicated, the apparatus according to the invention includes the third forming unit 21, which is vertically movable relative to the base plate 11 and which is adapted to be moved by an actuator between a raised position and a lowered position, in which a mold member 22 (see FIG. 16) of the third forming unit 21, cooperates with an upper surface 34 of the die structure 31, to bring the bidimensional U-shaped blank H′ into a final hairpin H (FIG. 18) with a three-dimensional shape.

In the illustrated example, the actuator of the third forming unit 21 is a pneumatic cylinder 5 having its axis oriented vertically and supported on a cross-member 2B, spanning between the two upper ends of two columns 2A forming part of the frame 2. The illustrated configuration of frame 2 is purely an example.

When the mold member 22 of the third forming unit 21 is moved from its raised position to its lowered position, the central bridge portion of the U-shaped blank H′ is pressed between the lower end of the mold member 22 and the upper edge of the stationary mold member 34 (see FIG. 16), so as to obtain the final desired three-dimensional shape shown in FIGS. 8 and 18.

The operation of the above-described apparatus is as follows.

Firstly, a wire 52 is positioned, for example with the aid of the clamping jaw 51 of FIG. 5, on the two supports 53. Once the wire has been loaded, the actuator 3 of the first forming unit 12 is activated, so that the mold member 14 of the first forming unit 12 engages the central portion of the wire 52 and brings it against the die member 32, while opposite portions of the wire 52 are compelled to be bent in a bidimensional U-shaped blank H′ by support portions 53A. With the first forming unit 12 in this position, the actuator 4 of the second forming unit 13 is activated, so that the lateral arms (e.g., lateral pushing members) 46 are compelled by the cooperating rollers 45 to push the two legs H1′ of the bidimensional U-shaped blank H′ laterally inwardly, through the engaging rollers 54. In this manner, when the second forming unit 13 is returned to its rearward position, the two legs H1′ of the bidimensional U-shaped blank H′ return to a substantially parallel condition, in spite of any spring-back effect. Before or after the return of the second forming unit 13 to its rearward position, the actuator 5 of the third forming unit 21 is activated, so that the bidimensional U-shaped blank H′ is brought to the three-dimensional shape of a final product H (FIG. 18), due to the cooperation of the vertically moving mold member 22 and the die member 34.

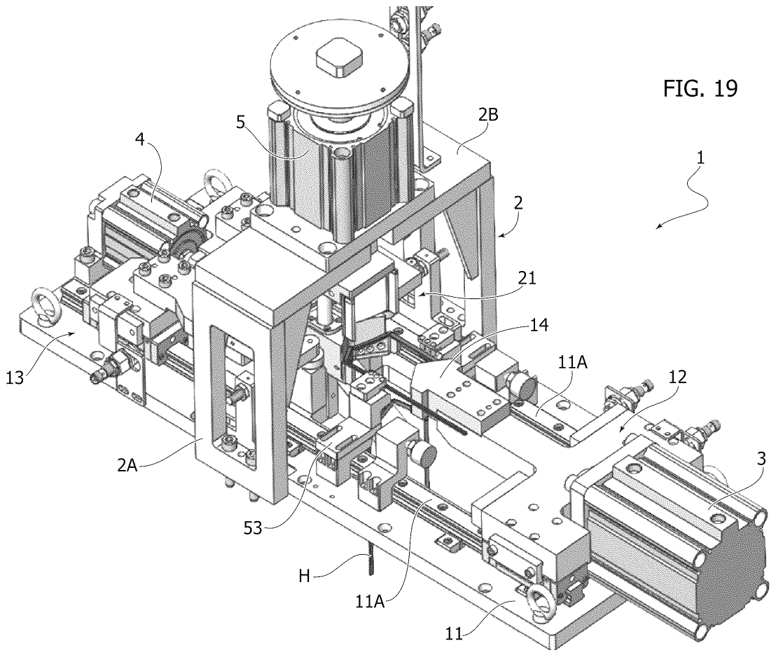

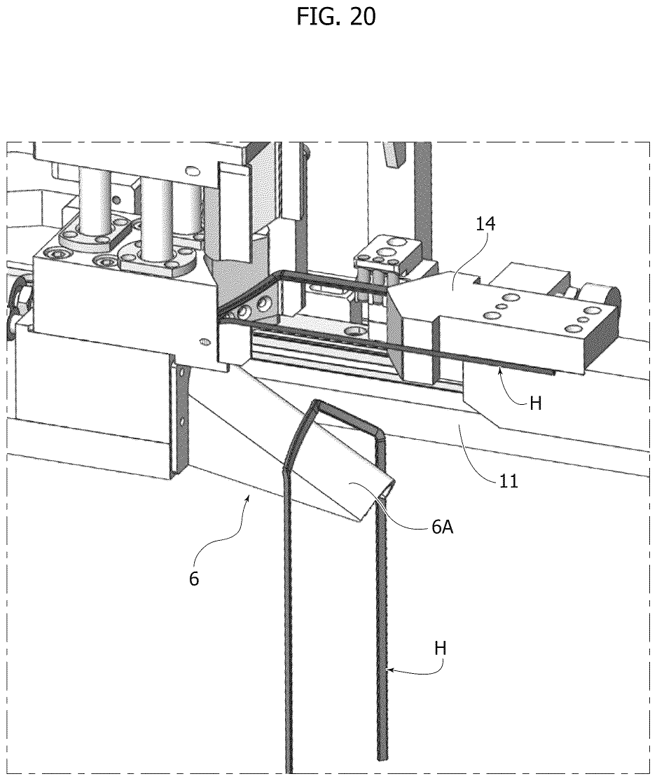

After that all these operations have been completed, the first forming unit 12, the second forming unit 13 and the third forming unit 21 are returned to their starting positions (see FIG. 19) so that the final product H is free to fall, by gravity, as shown in FIG. 20, on a sliding surface 6A of a support 6 carried by the base plate 11. In this manner, the final product can be easily and rapidly forwarded to a position from which it can be transferred to other stations of the production line.

Naturally, while the principle of the invention remains the same, the details of construction and the embodiments may widely vary with respect to what has been described purely by way of example, without departing from the scope of the present invention, as defined in the appended claims.

1. Apparatus for shaping a flat wire having a flat cross-section into a form of a hairpin having a general U-shape, with two substantially parallel legs connected by a bridge portion, for use in a manufacture of a motor stator, said apparatus comprising:
a stationary base plate;
a pair of wire stationary supports provided on the stationary base plate which are configured to hold a substantially straight wire along a horizontal wire support direction, by holding the substantially straight wire at two locations which are spaced apart from each other;
a first forming unit which is slidably mounted on the stationary base plate along a horizontal first axis orthogonal to said horizontal wire support direction, and which is configured to be moved by an actuator of the first forming unit from a first rearward position towards a second forward position;
a stationary die structure carried by said stationary base plate and configured to cooperate with a mold member of the first forming unit as a result of a movement of the first forming unit from the first rearward position to the second forward position, so as to form said substantially straight wire into a bidimensional shaped blank having a V-shaped bridge portion and two legs of the bidimensional shaped blank;
a second forming unit which is slidably mounted on the stationary base plate along said horizontal first axis, and which is configured to be moved by an actuator of the second forming unit from a third rearward position to a fourth forward position, in a direction contrary to a direction of the movement of the first forming unit from the first rearward position to the second forward position,
wherein said second forming unit comprising lateral pushing members configured to slightly push laterally inwardly the two legs of said bidimensional shaped blank as a result of a movement of the second forming unit towards the fourth forward position, so as to compensate for any spring-back effect of the two legs, thereby leaving the two legs substantially parallel to each other when the second forming unit is returned to the third rearward position; and
a third forming unit which is vertically movable relative to the stationary base plate and which is configured to be moved by an actuator of the third forming unit from a raised position to a lowered position in which a mold member of the third forming unit cooperates with a stationary mold member of the stationary die structure to form said bidimensional shaped blank into a final three-dimensional shape.

2. The apparatus according to claim 1, wherein said mold member of the first forming unit comprises a pointed front portion of the first forming unit, and wherein said stationary die structure comprises a first die member configured to cooperate with the mold member of the first forming unit, when the first forming unit is in the second forward position, so as to form a central portion of the substantially straight wire into the V-shaped bridge portion of the bidimensional shaped blank.

3. The apparatus according to claim 2, wherein said pair of wire stationary supports are located and configured so as to act as additional die members, by compelling two opposite portions of the substantially straight wire to be bent to form said two legs of the bidimensional shaped blank when a central portion of the substantially straight wire is pushed between and beyond the the pair of wire stationary supports by the mold member of the first forming unit as a result of the movement of the first forming unit towards the second forward position,
wherein the movement of the first forming unit toward the second forward position causes the forming of the V-shaped bridge portion and also of the two parallel legs of said bidimensional blank.

4. The apparatus according to claim 1, wherein said second forming unit comprises:
a slide structure movable along said horizontal first axis on the stationary base plate;
said lateral pushing members comprising two lateral arms carried by said slide structure and configured for transverse movement with respect to said horizontal first axis relative to the slide structure;
wire engaging elements carried by said lateral arms and configured to laterally engage the two legs of said bidimensional blank from outside; and
cams configured to cause the transverse movement of said two lateral arms as a result of the movement of the second forming unit from the third rearward position to the fourth forward position, in such a way that said wire engaging elements push laterally inwardly the two legs of said bidimensional shaped blank towards each other, so that when the second forming unit is returned to the third rearward position, the two legs of the bidimensional blank return to a position in which they are substantially parallel to each other.

5. The apparatus according to claim 4, wherein said two lateral arms are pivotally mounted on vertical axes on said slide structure of the second forming unit, and wherein said cams comprise cam surfaces provided on said lateral arms and configured for engaging cooperating members, so that a movement of the slide structure from said third rearward position to said fourth forward position causes a rotation of the two lateral arms towards each other, and so that said wire engaging elements carried by said two lateral arms push the two legs of said bidimensional blank towards each other.

6. The apparatus according to claim 4, wherein said wire engaging elements comprise freely rotatable rollers carried by said two lateral arms.

7. The apparatus according to claim 5, wherein said cooperating members comprise freely rotatable rollers carried by stationary supports and wherein, springs are operatively interposed between each of said lateral pivoting arms and the slide structure, urging each lateral pivoting arm against the respective cooperating roller.

8. The apparatus according to claim 7, wherein each cooperating roller is adjustable in position along a direction orthogonal to said horizontal first axis.

9. A method for shaping a flat wire into a form of a hairpin having a general U-shape, with two substantially parallel legs connected by a bridge portion, for use in a manufacture of a motor stator, said method including:
providing a stationary base plate;
holding a substantially straight wire along a horizontal wire support direction, by a pair of stationary supports provided on the stationary base plate, the pair of stationary supports holding the substantially straight wire at two locations which are spaced apart from each other;
providing a first forming unit which is slidably mounted on the stationary base plate along a horizontal first axis orthogonal to said horizontal wire support direction, and moving the first forming unit, by an actuator of the first forming unit, from a first rearward position towards a second forward position, in which a mold member of the first forming unit cooperates with a stationary die structure carried by said stationary base plate, so as to form said substantially straight wire into a bidimensional shaped blank having a V-shaped bridge portion and two legs;
providing a second forming unit which is slidably mounted on the stationary base plate along said horizontal first axis, and moving said second forming unit, by an actuator of the second forming unit, from a third rearward position to a fourth forward position, in a direction contrary to a direction of a movement of the first forming unit from the first rearward position to the second forward position,
wherein said second forming unit comprising lateral pushing members configured to slightly push laterally inwardly the two legs of said bidimensional shaped blank as a result of the movement of the second forming unit towards the fourth forward position, so as to compensate for any spring-back effect of the two legs, thereby leaving the two legs substantially parallel to each other when the second forming unit is returned to the third rearward position; and
providing a third forming unit which is vertically movable relative to the stationary base plate and moving the third forming unit, by an actuator of the third forming unit, from a raised position to a lowered position in which a mold member of the third forming unit cooperates with a stationary mold member of the stationary die structure to form said bidimensional shaped blank into a final three-dimensional shape.
